(19) United States
(12) Patent Application Publication
(10) Pub. No.: US 2008/0090958 A1
(43) Pub. Date: Apr. 17, 2008

(54) Moulds With High Light Dispersion And High Light Transmission

(75) Inventors: Claus Rüdiger, Krefeld (DE); Rüdiger Gorny, Moon Twp., PA (US); Marco Roelofs, Krefeld (DE); Ilona Christine Roelofs, Krefeld (DE); Lars Roelofs, Krefeld (DE); Jürgen Röhner, Köln (DE); Peter Schwarz, Krefeld (DE)

Correspondence Address: BAYER MATERIAL SCIENCE LLC, 100 BAYER ROAD, PITTSBURGH, PA, 15205, US

(73) Assignee: BAYER MATERIALSCIENCE AG, Leverkusen (DE)

(21) Appl. No.: 11/658,277

(22) PCT Filed: Jul. 18, 2005
(86) PCT No.: PCT/EP05/07789

§ 371 Date: Jun. 7, 2007

(30) Foreign Application Priority Data
Jul. 26, 2004 (DE) 102004036249.1

(51) Int. Cl. C08G 63/02

(52) U.S. Cl. 525/10

(57) ABSTRACT

The present invention concerns a compound made of transparent thermoplastic resin, particularly polycarbonate, and a combination of inorganic particles on the basis of silicone dioxide and polymer particles on an acrylate basis with core-shell morphology, as well as moulds made from this compound.

The following invention concerns a compound made of transparent thermoplastic resin, particularly polycarbonate, and a combination of inorganic particles on the basis of silicone dioxide and polymer particles on an acrylate basis with core-shell morphology, as well as moulds made from this compound.

This compound or mould exhibits a high degree of light transmission and high light dispersion simultaneously, and can be used in many areas where simultaneous high light transmission and high light dispersion is desired. Such uses are coverings for lighting systems, for example, in which the typically used punctual light sources are not to be used as such, rather the light is to be emitted evenly over a large area. These types of lighting systems are used in interior lighting in rooms, stairways, halls, or means of transport such as a train, motor, and aeroplane.

In the electronics industry, light-dispersing plates are used in lighting systems for flat monitors (LCD monitors), for example. Simultaneous high light dispersion and high light transmission is a great advantage in this case as well. The lighting system of such flat monitors can either be realised with lateral light connections (edgelight system) or, in the case of larger monitors where lateral light connections are no longer sufficient, by using a backlight unit in which the direct light behind the diffuser plate must be distributed in as even a manner as possible.

Light-dispersing translucent products made from polycarbonate with various light-dispersing additives are known from the state of the art.

For example, EP-A 634 445 describes light-dispersing compounds, which contain particles on a vinyl-acrylate basis with core-shell morphology in combination with TiO₂.

In DE-A 22 51 708, the use of barium sulphate as a dispersion pigment in transparent thermoplastic resins is described.

The use of light-dispersing polycarbonate foils in flat monitors is described in US 2004/0066645. In this case, polyacrylates, PMMA, polytetrafluoroethylenes, polyalkyltrialkoxysiloxanes, and mixtures of these particles are mentioned as light-dispersing pigments.

The known light-dispersing compounds do not yet exhibit sufficient light transmission at the specified level of light-dispersion, however.

It was found, surprisingly, that this desired combination of characteristics could be obtained with a compound containing a transparent thermoplastic resin, particularly polycarbonate, and a combination of inorganic particles on the basis of silicone dioxide and polymer particles on the basis of acrylate with core-shell morphology. The inorganic particles can be directly incorporated into the polycarbonate without further treatment according to prevalent compounding techniques, or they can receive a coating and then be incorporated. The compounds produced in this manner surprisingly exhibit an extraordinarily high light transmission with the simultaneous specified light dispersion. In particular, at the same level of light dispersion there is surprisingly an increased level of light transmission with the combination of inorganic and organic dispersion pigments in comparison to the individual dispersion pigments.

The subject of the present invention is therefore a compound containing 60 to 99.98% by weight of a transparent thermoplastic resin, particularly polycarbonate, 0.01 to 20% by weight, preferably 0.1 to 10% by weight, or most preferably 0.1 to 5% by weight of inorganic particles on the basis of silicone dioxide, and 0.01 to 20% by weight, preferably 0.1 to 10% by weight, or most preferably 0.1 to 5% by weight of polymer particles on an acrylate basis with core-shell morphology.

Suitable transparent thermoplastic resins for the production of moulds forming the basis of this invention are e.g. polycarbonate, copolyestercarbonates, polyester, copolyester, blends of polycarbonate and polyesters or copolyesters, polymethylmethacrylate, polyethylmethacrylate, styrene acrylonitrile copolymer or mixtures of these, while polycarbonate, copolyestercarbonates, polyester, copolyester, transparent blends of polycarbonate and polyesters or copolyesters are preferred, and polycarbonate is particularly preferred.

Suitable polycarbonates for the production of the invention-related multi-layer products are all known polycarbonates. These are homopolycarbonates, copolycarbonates, and thermoplastic polyestercarbonates.

The suitable polycarbonates have a preferred average molecular weight M_{w} of 18,000 to 40,000, preferably from 26,000 to 36,000, and most preferably from 28,000 to 35,000, calculated by measuring the relative solution viscosity in dichloromethane or in mixtures containing the same percentage by weight of phenol/o-dichlorobenzol, gauged via light dispersion.

Examples of reference works for the production of polycarbonates are “Schnell, Chemistry and Physics of Polycarbonates, Polymer Reviews, Vol. 9, Interscience Publishers, New York, London, Sydney 1964”, “D. C. PREVORSEK, B. T. DEBONA, and Y. KESTEN, Corporate Research Center, Allied Chemical Corporation, Morristown, N.J. 07960, ‘Synthesis of Poly(ester)carbonate Copolymers’ in Journal of Polymer Science, Polymer Chemistry Edition, Vol. 19, 75-90 (1980)”, “D. Freitag, U. Grigo, P. R. Muller, N. Nouvertne, BAYER A G, ‘Polycarbonates’ in Encyclopaedia of Polymer Science and Engineering, Vol. 11, Second Edition, 1988, pages 648-718”, and finally “Dr. U. Grigo, Dr. K. Kircher, and Dr. P. R. Muller ‘Polycarbonates’ in Becker/Braun, Polymer Handbook, Volume 3/1, Polycarbonates, Polyacetals, Polyester, Celluloseester, Carl Hanser Verlag Munich, Vienna 1992, pages 117-299”.

The production of polycarbonates preferably occurs according to the phase boundary method or the ester interchange method, and in the following sections the process will be described using the phase boundary method.

As initial compounds, preferable compounds to be used are bisphenols of the general formula
HO-Z-OH,
where,

Z is a divalent organic moiety with 6 to 30 carbon atoms, which contains one or more aromatic groups.

Examples of such compounds are bisphenols that belong to the group of dihydroxydiphenyls, bis(hydroxyphenyl)alkanes, indane bisphenols, bis(hydroxyphenyl)ether, bis(hydroxyphenyl)sulphones, bis(hydroxyphenyl)ketones, and α,α′-bis(hydroxyphenyl)-diisopropylbenzoles.

Particularly preferred bisphenols that belong to the aforementioned compound groups are bisphenol-A, tetraalkylbisphenol-A, 4,4-(meta-phenylenediisopropyl)diphenol (bisphenol M), 4,4-(para-phenylenediisopropyl)-diphenol, 1,1-bis-(4-hydroxyphenyl)-3,3,5-trimethylcyclohexane (bisphenol TMC), and mixtures of these.

Preferably, the bisphenol compounds to be used, according to the invention, are reacted with carbonic acid compounds, particularly phosgene, or in the case of the ester interchange process, with diphenylcarbonate or dimethylcarbonate.

Polyestercarbonates are preferably obtained through reactions with the previously mentioned bisphenols, at least one aromatic dicarboxylic acid, and possibly carbonic acid equivalents. Suitable aromatic dicarboxylic acids are phthalic acid, terephthalic acid, isophthalic acid, 3,3′- or 4,4′-diphenyldicarboxylic acid, and benzophenonedicarboxylic acids. A portion of the carbonate group in the polycarbonates, up to 80-mol %, preferably from 20 to 50-mol %, can be replaced by aromatic dicarboxylic acid ester groups.

In the phase boundary method, inert organic solvents used are e.g. dichloromethane, the various dichloroethanes and chloropropane compounds, tetrachloromethane, trichloromethane, chlorobenzol, and chlorotoluol, while chlorobenzol or dichloromethane or mixtures of dichloromethane and chlorobenzol are preferably used.

The phase boundary reaction can be accelerated by catalysts such as tertiary amines, particularly N-alkylpiperidines or onium salts. Tributylamine, triethylamine, and N-ethylpiperidine are used preferably. In the case of the ester interchange process, the catalysts mentioned in DE-A 42 38 123 are preferably used.

The polycarbonates can be branched in a controlled manner by using small amounts of branching agents. Some suitable branching agents are: phloroglucinol, 4,6-dimethyl-2,4,6-tri-(4-hydroxyphenyl)-heptane-2; 4,6-dimethyl-2,4,6-tri-(4-hydroxyphenyl)-heptane; 1,3,5-tri-(4-hydroxyphenyl)-benzol; 1,1,1-tri(4-hydroxyphenyl)-ethane; tri-(4-hydroxyphenyl)-phenylmethane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-ortho-terephthalic acid ester; tetra-(4-hydroxyphenyl)-methane; tetra-(4-(4-hydroxyphenyl-isopropyl)-phenoxy)-methane; α,α′,α″-tris-(4-hydroxyphenyl)-1,3,5-triisopropylbenzol; 2,4-dihydroxybenzoic acid; trimesinic acid; cyanuric chloride; 3,3-bis-(3-methyl-4-hydroxyphenyl)-2-oxo-2,3-dihydroindol; 1,4-bis-(4′,4″-dihydroxytriphenyl)-methyl)-benzol, and particularly: 1,1,1-tri-(4-hydroxyphenyl)-ethane and bis-(3-methyl-4-hydroxyphenyl)-2-oxo-2,3-dihydroindol.

The possibly used 0.05 to 2-mol % of diphenols, branching agents, or mixtures of branching agents, can be used together with the diphenols or added in a later stage of synthesis.

As chain breakers, phenols are preferably used, such as phenol, alkylphenols like cresol, and 4-tert-butylphenol, chlorophenol, bromophenol, cumylphenol, or mixtures of these in amounts of 1 to 20-mol %, preferably 2 to 10-mol % per mol bisphenol. Phenol, 4-tert-butylphenol and cumylphenol are preferred.

Chain breakers and branching agents can be added to the compounds separately or together with the bisphenol.

An example of the production of polycarbonates according to the ester interchange process is described in DE-A 42 38 123.

Preferred polycarbonates for the invention are the homopolycarbonate on the basis of bisphenol A, the homopolycarbonate on the basis of 1,1-bis-(4-hydroxyphenyl)-3,3,5-trimethylcyclohexane, and the copolycarbonates on the basis of the two monomers bisphenol A and 1,1-bis-(4-hydroxyphenyl)-3,3,5-trimethylcyclohexane, and the copolycarbonates on the basis of the two monomers bisphenol A and 4,4′-dihydroxydiphenyl (DOD).

The homopolycarbonate on the basis of bisphenol A is preferred.

The inorganic particles on the basis of silicone dioxide a) to be used, according to the invention, are preferably amorphous silicic acid, which exhibits a pH value from 5 to 9 in an aqueous suspension, preferably from 6 to 8.

The particle size of the used inorganic particles on the basis of silicone dioxide is from 1 to 100 μm, preferably from 2 to 50 μm, and most preferably from 5 to 20 μm.

Particularly suitable inorganic particles on the basis of silicone dioxide are those that can be compounded into polycarbonate without further treatment, and without causing significant polycarbonate decomposition. This condition is met in the case of the current invention if, when compounding the inorganic particles on the basis of silicone dioxide on a 5% by weight basis into polycarbonate, the MVR does not increase by more than 100 cm³/10 min. according to ISO 1133.

The production of the inorganic particles on the basis of silicone dioxide is principally described in Hollemann-Wiberg (101^{st} Edition) or in the Rompp Chemistry Lexicon—Version 2.0, Stuttgart/New York, Georg Thieme Verlag 1999.

They can be obtained synthetically from the raw material sand, and are also designated as amorphous silicic acids. In the first step, quartz sand and alkali carbonate are melted together at approx. 1300 degrees C. The resulting alkali silicates are then dissolved at a high temperature and high pressure in overheated water (e.g. at 150 degrees C. and 5 bars of pressure). The amorphous silicic acids described can be produced from this aqueous alkali silicate solution by mineral acid precipitation.

First colloidal primary particles are formed, which agglomerate in a progressive reaction and finally grow into aggregates. In the case of silicone dioxide particles obtained according to this production process (wet method), it is significant that when the silicone dioxide particles are formed, there is a very small amount of alkaline embeddings present in the particles. This is apparent in the aqueous suspension on the one hand, in which the pH value of this silicone dioxide suspension is from 5 to 9, preferably from 6 to 8, and in the behaviour of these particles in the polycarbonate itself on the other hand, where the MVR according to ISO 1133 is allowed to be no higher than 100 cm3/10 min.

As a second method for producing the described inorganic particles on the basis of silicone dioxide, there is the pyrogenic production process. In this method, silicone tetrachloride, which is obtained from (ferro)silicone by reacting it with chlorine, is decomposed in a detonating gas flame of hydrogen and oxygen. These particles are strongly hydrophilic through their free silanol groups, and can be hydrophobised by reacting them with chlorosilanes, for example. It is also necessary for the particles obtained according to the pyrolysis method that no large amounts of alkaline or acidic embeddings are present in the particles. This is once again apparent both in the aqueous suspension, in which the pH value measurement of these silicone dioxide suspensions is from 5 to 9, preferably from 6 to 8, and also in the behaviour of these particles in the polycarbonate itself, where the MVR according to ISO 1133 may not be higher than 100 cm3/10 min.

The described inorganic particles on the basis of silicone dioxide are characterised in that the mean density is between 0.2 and 1.2 g/mL and the particle size is from 1 to 100 μm, preferably between 2 and 50 μm, and most preferably between 5 and 20 μm. The purity of the described particles is more than 90% silicone dioxide content, preferably more than 95%, and most preferably more than 99%. The water content is less than 10%, preferably less than 5%, and most preferably less than 2%, determined by Karl Fischer (160 degrees C.). The shape of the particles can be oval or round with a diameter of less than 10.

The durability of the described inorganic particles on the basis of silicone dioxide with polycarbonate can be further improved if they are given a silicone coating. The higher durability with polycarbonate is apparent by a lower MVR in the mixture made of the coated inorganic particles on the basis of silicone dioxide with polycarbonate in comparison to a corresponding mixture made of uncoated inorganic particles on the basis of silicone dioxide.

As a silicone coating, polymethylhydrosiloxane can be used, for example, which can be applied to the previously described inorganic particles on the basis of silicone dioxide with known methods.

In the case of the polymer particles on an acrylate basis with core-shell morphology to be used, according to the invention, such particles are preferred as those that are announced in EP-A 634 445.

The polymer particles b) have a core made of caoutchouc vinyl polymers. The caoutchouc vinyl polymers can be homo or copolymers from any of the monomers, which possess at least one ethylene type unsaturated group, and that suggest themselves to the expert in the area of known addition polymerisation under the conditions of emulsion polymerisation in an aqueous medium. Such monomers are listed in U.S. Pat. No. 4,226,752, column 3, lines 40-62.

The caoutchouc vinyl polymers preferably contain at least 15%, more preferably at least 25%, most preferably at least 40%, of a polymerised acrylate, methacrylate, monovinylarene, or optionally substituted butadiene, and from 0 to 85%, preferably from 0 to 75%, most preferably from 0 to 60% of one or more copolymerised vinyl monomers, with respect to the total weight of the caoutchouc vinyl polymer.

Preferred acrylates and methacrylates are alkylacrylates or alkylmethacrylates, which preferably contain 1 to 18, more preferably 1 to 8, and most preferably 2 to 8 carbon atoms in the alkyl group, such as methyl, ethyl, n-propyl, isopropyl, n-butyl, sec-butyl or tert-butyl or hexyl, heptyl, or octyl groups. The alkyl group can be branched or linear. The preferred alkyl acrylates are ethylacrylate, n-butylacrylate, isobutylacrylate, and 2-ethylhexylacrylate. The most preferred alkylacrylate is butylacrylate.

Other suitable acrylates are, for example, 1,6-hexanedioldiacrylate, ethylthioethylmethacrylate, isobornylacrylate, 2-hydroxyethylacrylate, 2-phenoxyethylacrylate, glycidylacrylate, neopentylglycoldiacrylate, 2-ethoxyethylacrylate, t-butylaminoethylmethacrylate, 2-methoxyethylacrylate, glycidylmethacrylate, and benzylmethacrylate.

Preferred monovinylarenes are styrene or α-methylstyrene, optionally substituted by an alkyl group on the aromatic ring, such as methyl, ethyl, or tertiary butyl, or by a halogen such as chlorostyrene.

If substituted, the butadiene preferably has one or more alkyl groups, which contain 1 to 6 carbon atoms, or with one or more halogens, the most preferred is butadiene with one or more methyl groups and/or one or more chlorine atoms substituted. Preferred substituted butadienes are 1,3-butadiene, isoprene, chlorobutadiene, and 2,3-dimethyl-1,3-butadiene.

The caoutchouc vinyl polymers can contain one or more (co)polymerised acrylates, methacrylates, monovinylarenes, and/or optionally substituted butadienes. These monomers can be copolymerised with one or more additional copolymerisable vinyl polymers, such as diacetoneacrylamide, vinylnaphthaline, 4-vinylbenzyl alcohol, vinylbenzoate, vinylpropionate, vinylcaproate, vinylchloride, vinyloleate, dimethylmaleate, maleic acid anhydride, dimethylfumarate, vinylsulfonic acid, vinylsulfonamide, methylvinylsulfonate, n-vinylpyrrolidone, vinylpyridine, divinylbenzol, vinylacetate, vinylversatate, acrylic acid, methacrylc acid, n-methylmethacrylamide, acrylnitrile, methacryinitrile, acrylamide, or n-(isobutoxymethyl)-acrylamide.

One or more of the aforementioned monomers can be optionally reacted with 0 to 10%, preferably with 0 to 5% of a copolymerisable, polyfunctional cross linking agent and/or with 0 to 10%, preferably with 0 to 5% of a copolymerisable polyfunctional graft cross linking agent, with respect to the total core weight. If a cross-linking monomer is used, it is preferably used with a content of 0.05 to 5%, more preferably 0.1 to 1%, with respect to the total weight of the core of the monomers. Cross-linking monomers are well-known in the industry, and generally have a polyethylene-type unsaturation, in which the ethylene-type unsaturated groups possess almost the same reactivity, such as divinylbenzole, trivinylbenzole, 1,3- or 1,4-triolacrylate or -methacrylate, glycol-di- or -tri-methacrylate or -acrylates, such as ethyleneglycoldimethacrylate or -diacrylate, propyleneglycoldimethacrylate or -diacrylate, 1,3- or 1,4-butylenegylcoldimethacrylate or most preferably 1,3- or 1,4-butyleneglycoldiacrylate. If a graft cross-linking monomer is used, it is preferably used with a content of 0.1 to 5%, more preferably of 0.5 to 2.5%, with respect to the total weight of the core of the monomers. Graft cross-linking monomers are well known in the industry, and are generally polyethylene-type unsaturated monomers, which possess a sufficiently low reactivity of the unsaturated groups so that significant residual unsaturation is possible, which remains in the core following polymerisation. Preferred graft cross-linking agents are copolymerisable allyl, methallyl, or crotyl esters of α,β-ethylene-type unsaturated carboxylic acids or dicarboxylic acids, such as allylmethacrylate, allylacrylate, diallylmaleate, and allylacryloxypropionate, while allylmethacrylate is most preferred.

The polymer particles b) most preferably contain a core of caoutchouc alkylacrylate polymers, in which the alkyl group exhibits from 2 to 8 carbon atoms, optionally copolymerised with from 0 to 5% cross-linking agents and from 0 to 5% graft cross-linking agents, with respect to the total weight of the core. The caoutchouc alkylacrylate is preferably copolymerised with up to 50% of one or more copolymerisable vinyl monomers, for example those aforementioned. Suitable cross-linking and graft cross-linking monomers are well known to the industry professional, and those are preferred that are described in EP-A 0 269 324.

The core of the polymer particles b) can contain residual oligomer material, which was used in the polymerisation process, in order to create the polymer particles, however such oligomer material has a sufficient molecular weight to prevent its diffusion or to prevent its extraction during processing or use.

The polymer particles b) contain one or more shells. These one or more shells are preferably produced from vinylhomopolymers or vinylcopolymers. Suitable monomers for producing the shell or shells are listed in U.S. Pat. No. 4,226,752, column 4, lines 20-46, and reference is made to this information. The one or more shells are preferably a polymer consisting of a methacrylate, acrylate, vinylarene, vinylcarboxylate, acrylic acid, and/or methacrylic acid.

Preferred acrylates and methacrylates are alkylacrylates or alkylmethacrylates, which preferably contain 1 to 18, more preferably contain 1 to 8, and most preferably contain 2 to 8 carbon atoms in the alkyl group, such as methyl, ethyl, n-propyl, isopropyl, n-butyl, isobutyl or tert-butyl, 2-ethylhexyl, hexyl, heptyl, or octyl groups. The alkyl group can be branched or linear. The preferred alkylacrylate is ethylacrylate. Other usable acrylates and methacrylates are those that were previously mentioned for the core, while the 3-hydroxypropylmethacrylate is preferred. The most preferred alkylacrylate is methylmethacrylate.

Preferred vinylarenes are styrene or α-methylstyrene, optionally substituted by an alkyl group on the aromatic ring, such as methyl, ethyl, or tert-butyl, or by α, halogen such as chlorostyrene.

A preferred vinylcarboxylate is vinylacetate.

The shell(s) preferably contain(s) at least 15%, more preferably at least 25%, most preferably at least 40% of a polymerisable methacrylate, acrylate, or

monovinylarene, and 0 to 85%, more preferably 0 to 75%, and most preferably 0 to 60% of one or more vinylcomonomers, such as other alkylmethacrylates, arylmethacrylates, alkylacrylates, arylacrylates, alkylacrylamides and arylacrylamides, acrylnitrile, methacrylnitrile, maleic imide, and/or alkylacrylates, arylacrylates, and alkylmethacrylates, which are substituted by one or more substituents such as halogen, alkoxy, alkylthio, cyanoalkyl, or amino. Examples of suitable vinylcomonomers were given previously. Two or more monomers can be copolymerised.

The shell polymers can contain a cross-linking agent and/or a graft cross-linking agent of the type that was previously mentioned with reference to the core polymers.

The shell polymers preferably make up from 5 to 40%, more preferably from 15 to 35% of the total particle weight.

The polymer particles b) contain at least 15%, preferably from 20 to 80%, more preferably from 25 to 60%, and most preferably from 30 to 50% of a polymerised alkylacrylate or alkylmethacrylate, with respect to the total weight of the polymer. Preferred alkylacrylates and alkylmethacrylates were mentioned previously. The alkylacrylate or alkylmethacrylate component can be present in the core and/or in the shell(s) of the polymer particles b). Homopolymers of an alkylacrylate or alkylmethacrylate in the core and/or in the shell(s) are usable, however an alkyl(meth)acrylate is preferred that is copolymerised with one or more other types of alkyl(meth)acrylates and/or one or more other vinyl polymers, preferably with one of those listed above. The polymer particles b) most preferably contain a core made of a poly-(butylacrylate) and a shell or several shells made of poly(methylmethacrylate).

The polymer particles b) are useful for providing the thermoplastic polymers with light dispersion properties. The index of refraction n of the core and of the shell(s) of the polymer particles b) is preferably within +/−0.25 units, more preferably +/−0.8 units, and most preferably +/−0.12 units of the index of refraction of the thermoplastic polymers. The index of refraction n of the core and of the shell(s) is preferably no closer than +/−0.003 units, more preferably no closer than +/−0.01 units, and most preferably no closer than +/−0.05 with respect to the index of refraction of the thermoplastic polymers. The index of refraction is measured according to the ASTM D 542-50 and/or DIN 53 400 standard.

The polymer particles b) generally have an average particle diameter of at least 0.5 micrometers, preferably at least 2 micrometers, more preferably from 2 to 50 micrometers, and most preferably from 2 to 15 micrometers. “Average particle diameter” is understood as the numerical average. Preferably at least 90%, most preferably at least 95% of the polymer particles b) have a diameter of more than 2 micrometers. The polymer particles b) are preferably a free-flowing powder.

The polymer particles b) can be manufactured according to known methods. In general, at least one monomer component of the core polymer is subjected to emulsion polymerisation under the formation of emulsion polymer particles. The emulsion polymer particles are swollen with the same or one or more additional monomer components of the core polymer, and the monomer(s) is/are polymerised within the emulsion polymer particles. The swelling and polymerisation steps can be repeated until the particles grow to the desired core size. The core polymer particles are suspended in a second aqueous monomer emulsion, and a polymer shell is polymerised from the monomer(s) onto the polymer particles in the second emulsion. One or more shells can be polymerised on the core polymer. The production of core/shell polymer particles is described in EP-A 0 269 324 and in U.S. Pat. Nos. 3,793,402 and 3,808,180.

The moulds made from the invention-related compounds, which are a second subject of the current invention, can either be produced by extrusion or injection die-casting. In the case of large solid slabs, the production by means of injection die-casting is not economical for technical reasons. In these cases, the extrusion process is preferred. For the extrusion process, a polycarbonate granulate is fed into the extruder, and melted in the extruder's plastification system. The synthetic flux is pressed by a wide slot nozzle, and thus shaped and moulded into the desired final form in the nip of a smoothing calender, and fixed by being cooled on the smoothing rolls and by ambient air. The polycarbonates with high melt viscosity used for the extrusion are typically processed at melting temperatures of 260 to 320 degrees C., and the cylinder temperatures of the plasticising cylinder as well as the nozzle temperatures are set accordingly.

Through the use of one or more lateral extruders and suitable cast adapters upstream of the wide slot nozzle, polycarbonate fluxes of various compositions can be layered on top of one another, and thus create multi-layered solid slabs (e.g. see EP-A 0 110 221 and EP-A 0 110 238).

Both the base layer and the possibly existing coextrusion layer(s) of the invention-related moulds can contain additional additives, such as UV-absorbers, and other customary processing additives, particularly demoulding agents and fluxing agents as well as the usual stabilisers, particularly thermostabilisers, as well as static inhibitors, colourants, optical brighteners, and inorganic pigments. Different additives or concentrations of additives can be present in every layer.

The coextrusion layer in particular can contain UV absorbers and demoulding agents.

Suitable stabilisers are, for example, phosphines, phosphites, or Si-containing stabilisers as well as other compounds described in EP-A 0 500 496. Examples are triphenylphosphites, diphenylalkylphosphites, phenyldialkylphosphites, tris-(nonylphenyl)phosphite, tetrakis-(2,4-di-tert-butylphenyl)-4,4′-biphenylene-diphosphonite, bis(2-4-dicumylphenyl)pentaerythritol diphosphite, and triarylphosphite. Triphenylphosphine and tris-(2,4-di-tert-butylphenyl)phosphite are particularly preferred.

Examples of suitable demoulding agents are the esters or partial esters of univalent to hexavalent alcohols, particularly glycerine, pentaerythritol, or Guerbet alcohols.

Examples of univalent alcohols are stearyl alcohol, palmityl alcohol, and Guerbet alcohols. An example of a divalent alcohol is glycol; an example of a trivalent alcohol is glycerine. Examples of tetravalent alcohols are pentaerythritol and mesoerythritol, while examples of pentavalent alcohols are arabitol, ribitol, and xylitol. Examples of hexavalent alcohols are mannitol, glucitol (sorbitol), and dulcitol.

The esters are preferably the monoesters, diesters, triesters, tetraesters, pentaesters, and hexaesters or mixtures of these, particularly static mixtures of saturated aliphatic C10 to C36 monocarboxylic acids and possibly hydroxy-monocarboxylic acids, preferably with saturated, aliphatic C₁₄ to C₃₂ monocarboxylic acids and possibly hydroxy-monocarboxylic acids.

The commercially available fatty acid esters, particularly of pentaerythritol and glycerine, can contain <60% of various partial esters, depending on the manufacturing process.

Examples of saturated aliphatic monocarboxylic acids with 10 to 36 C atoms are capric acid, lauric acid, myristic acid, palmitic acid, stearic acid, hydroxystearic acid, arachic acid, behenic acid, lignoceric acid, cerotic acid, and montanic acids.

Examples of preferred saturated aliphatic monocarboxylic acids with 14 to 22 C atoms are myristic acid, palmitic acid, stearic acid, hydroxystearic acid, arachic acid, and behenic acid.

Saturated aliphatic monocarboxylic acids like palmitic acid, stearic acid, and hydroxystearic acid are particularly preferred.

The saturated aliphatic C₁₀ to C₃₆ carboxylic acids and the fatty acid esters are either known as such from relevant literature or can be produced as such according to methods described in relevant literature. Examples for pentaerythritol fatty acid esters are the previously mentioned monocarboxylic acids, particularly those designated as preferred.

Esters of pentaerythritol and glycerine with stearic acid and palmitic acid are especially preferred.

Esters of Guerbet alcohols and glycerine with stearic acid, palmitic acid, and possibly hydroxystearic acid are also particularly preferred.

Examples of suitable static inhibitors are cation-active compounds, for example quaternary ammonium salts, phosphonium salts, or sulphonium salts, anion-active compounds such as alkylsulphonates, alkylsulphates, alkylphosphates, carboxylates in the form of alkali or earth-alkali metal salts, and non-ionogenic compounds such as polyethyleneglycol ester, polyethyleneglycol ether, fatty acid esters, and ethoxylated fatty amines. Preferred static inhibitors are non-ionogenic compounds.

Examples of suitable UV-absorbers are
a) Benzotriazole derivatives according to formula (I): 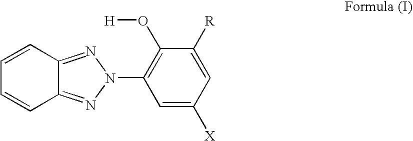
In formula (I), R and X are alike or different and represent H or alkyl or alkylaryl.
Preferred are: Tinuvin 329 with X=1,1,3,3-tetramethylbutyl and R=H,
Tinuvin 350 with X=tert-butyl and R=2-butyl, and
Tinuvin 234 with X=R=1,1-dimethyl-1-phenyl
b) Dimers benzotriazole derivatives according to formula (II):

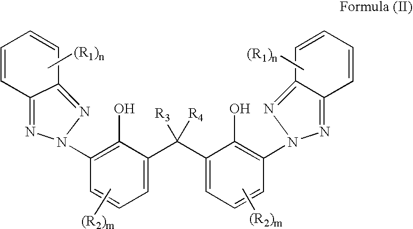

In formula (II), R¹ and R² are alike or different and represent H, halogen, C₁-C₁₀-alkyl, C₅-C₁₀-cycloalkyl, C₇-C₁₃-aralkyl, C₆-C₁₄-aryl, —OR⁵, or —(CO)—O—R⁵ where R⁵=H or C₁-C₄-alkyl.

In formula (II), R³ and R⁴ are also alike or different and represent H, C₁-C₄-alkyl, C₅-C₆-cycloalkyl, benzyl, or C₆-C₁₄-aryl.

In formula (II), m represents 1,2, or 3, and n represents 1,2,3, or 4.

Tinuvin 360 with R¹=R³=R⁴=H; n=4; R²=1,1,3,3-tetramethylbutyl; m=1 is preferred.
b1) Dimers benzotriazole derivatives according to formula (III): 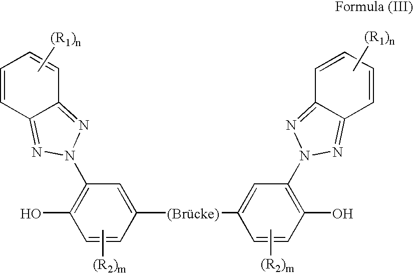
   Key: Brücke=Bridge
   where the bridge represents 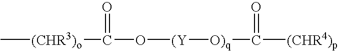
R¹, R², m, and n have the same meaning as in formula (II),
p is a whole number from 0 to 3,
q is a whole number from 1 to 10,
Y=—CH₂—CH₂—, —(CH₂)₃—, —(CH₂)₄—, —(CH₂)₅—, —(CH₂)₆—, or CH(CH₃)—CH₂, and
R³ and R⁴ have the same meaning as in formula (II).
Tinuvin 840 with R¹=H; n=4; R²=tert-butyl; m=1; R² is attached at the ortho position to the OH group; R³=R⁴=H; p=2; Y=—(CH₂)₅—; q=1 is preferred.
c) Triazine derivatives according to formula (IV): 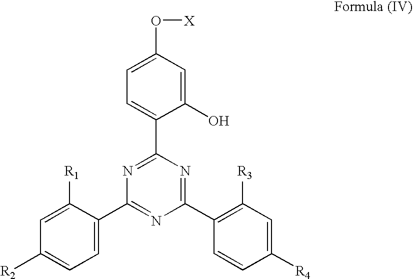
where R¹, R², R³, and R⁴ in formula (IV) are alike or different and represent H or alkyl or CN or halogen, and X=alkyl.
Tinuvin 1577 with R¹=R²=R³=R⁴=H; X=hexyl and
Cyasorb UV-1164 with R¹=R²=R³=R⁴=methyl; X=octyl are preferred.
d) Triazine derivatives of formula (IVa) (following page) 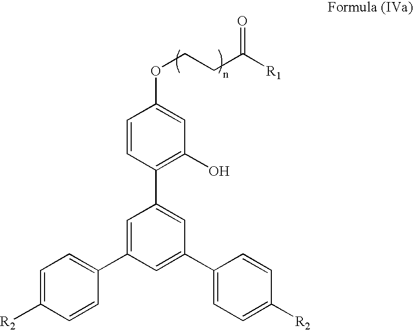
where
R¹=C₁-alkyl to C₁₇-alkyl,
R²=H or C₁-alkyl to C₄-alkyl, and
n=0 to 20.
e) Dimers triazine derivatives of formula (V): 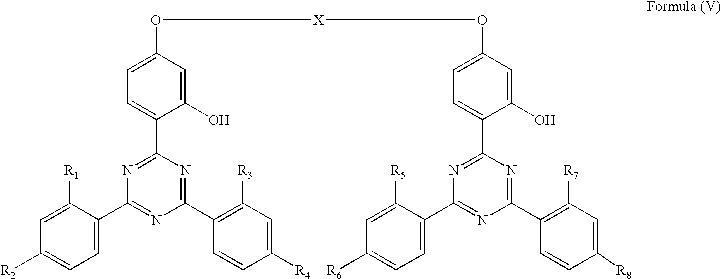
where
R¹, R², R³, R⁴, R⁵, R⁶, R⁷, and R⁸ in formula (V) can be the same or different and represent alkyl, CN, or halogen, and
X=alkyl or —(CH₂CH₂—O—)n-C(═O)—.
f) Diaryl cyanoacrylates of formula (VI): 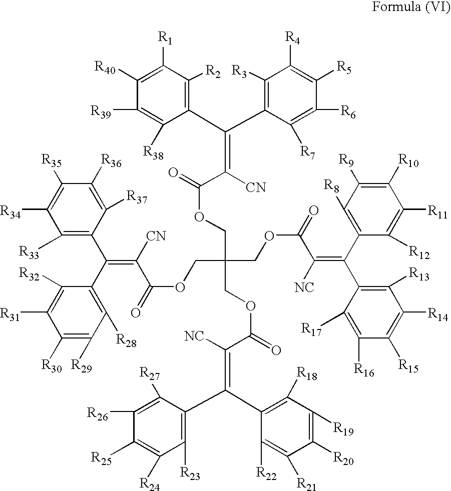
where R¹ to R⁴⁰ can be alike or different and represent H, alkyl, CN, or halogen.
Uvinul 3030 with R¹ to R⁴⁰=H is preferred.

The previously mentioned UV-absorbers are known to the industry professional and some of them are commercially available.

### EXAMPLES

MVR measurement of a compound consisting of 95% Makrolon 3108 550115 from Bayer Material Science and 5% Sylobloc 41 from Grace for determining the polycarbonate decomposition.

The aforementioned compound exhibits an MVR (ISO 1133) of 38 cm³/10 min at 300 degrees C., whereas pure Makrolon 3108 550115 has an MVR of 6 cm³/10 min.

### Example 1

A compound was produced with the following composition:
Polycarbonate Makrolon 3108 550115 from Bayer Material Science making up 99% by weight.
Core-shell particles with a butadiene/styrene core and a methylmethacrylate shell Paraloid EXL 5137 from Rohm & Haas with a particle size of 2 to 15 μm and an average particle size of 8 μm making up 1% by weight.

### Example 2

A compound was produced with the following composition:
Polycarbonate Makrolon 3108 550115 from Bayer Material Science making up 99% by weight.
Amorphous silicic acid Sylobloc 41 from Grace with a particle size of 7.5 to 11.6 μm making up 1% by weight.

### Example 3

A compound was produced with the following composition:
Polycarbonate Makrolon 3108 550115 from Bayer Material Science making up 98% by weight.
Core-shell particles with a butadiene/styrene core and a methylmethacrylate shell Paraloid EXL 5137 from Rohm & Haas with a particle size of 2 to 15 μm and an average particle size of 8 μm making up 2% by weight.

### Example 4

A compound was produced with the following composition:
Polycarbonate Makrolon 3108 550115 from Bayer Material Science making up 98% by weight.
Amorphous silicic acid Sylobloc 41 from Grace with a particle size of 7.5 to 11.6 μm making up 2% by weight.

### Example 5

A compound was produced with the following composition:
Polycarbonate Makrolon 3108 550115 from Bayer Material Science making up 99% by weight.
Core-shell particles with a butadiene/styrene core and a methylmethacrylate shell Paraloid EXL 5137 from Rohm & Haas with a particle size of 2 to 15 μm and an average particle size of 8 μm making up 0.5% by weight.
Amorphous silicic acid Sylobloc 41 from Grace with a particle size of 7.5 to 11.6 μm making up 0.5% by weight.

### Example 6

A compound was produced with the following composition:
Polycarbonate Makrolon 3108 550115 from Bayer Material Science making up 98% by weight.
Core-shell particles with a butadiene/styrene core and a methylmethacrylate shell Paraloid EXL 5137 from Rohm & Haas with a particle size of 2 to 15 μm and an average particle size of 8 μm making up 1% by weight.
Amorphous silicic acid Sylobloc 41 from Grace with a particle size of 7.5 to 11.6 μm making up 1% by weight.

The mixtures described in examples 1 to 6 were compounded using prevalent methods, and then processed into 4 mm thick colour sample plates using injection die-casting. The optical data was determined pursuant to ASTM D1003, ASTM E313, and DIN 5036. The corresponding optical values are presented in Table 1.

What is remarkable is that the light dispersion capability of examples 5 and 6, which both contain a combination of polymer particles on a vinylacrylate basis with core/shell morphology and amorphous silicic acid, is not, as expected, between the values for compounds that contain either amorphous silicic acid or polymer particles, rather they exhibit an almost identical light dispersion curve to a composition, which contains a significantly larger amount of polymer particles on a vinylacrylate basis with core/shell morphology. The half power angle of the sample from example 1 with 1% polymer particles on a vinylacrylate basis with core/shell morphology is 51°. That means that at an angle of deflexion of 51°, the light intensity is 50% of the light intensity at a zero degree angle of deflexion. In example 2, the half power angle is only 26°. In example 5, the half power angle is 49°, however, which is almost the same amount as in example 1.

It is particularly noteworthy that the light transmission in example 5 with 41.9% is considerably higher than the light transmission in example 1 with 37.2%. The dispersion ability, another variable for describing light dispersion, can be derived from the curves according to DIN 5036. It is calculated according to the following formula:

$$Dispersion ability [ \% ] = \frac{\begin{matrix}( light intensity at {20}^{°} ) \times \\ ( light intensity at {70}^{°} )\end{matrix}}{2 \times ( light intensity at {5}^{°} )}$$

In this respect, it is also clear that the dispersion ability in examples 1 and 5 is surprisingly at the same level with 55%.

The same is true of examples 3, 4, and 6. The light transmission in example 6, in which 1% polymer particles on a vinylacrylate basis with core/shell morphology are combined with amorphous silicic acid, with 32.6% is also considerably higher than the light transmission in example 3 of 31.2%, in which 2% polymer particles on a vinylacrylate basis with core/shell morphology were used exclusively. The half power angle of 61 degrees in example 6 is even slightly higher than the half power angle in example 3 of 60°. The difference in the dispersion ability is even clearer: the 65% in example 6 is clearly higher than the 62% in example 3.

TABLE 1
Optical Data from the Colour Sample Plates Made from the
Compounds in Examples 1 to 6 (4 mm Layer Thickness)

| Measurand | Standard | Example 1 | Example 2 | Example 5 | Example 3 | Example 4 | Example 6 |
|---|---|---|---|---|---|---|---|
| Light Transmission [%] (C2°) | ASTM D1003 | 37.2 | 63.4 | 41.9 | 31.2 | 47.7 | 32.6 |
| Yellowness Index (C2°) | ASTM E313 | 8.2 | 13.9 | 13.2 | 4.2 | 19.1 | 10.4 |
| Reflexion [%](C2°) | DIN 5036 | 22.7 | 12.8 | 19.4 | 32.1 | 16.5 | 26.8 |
| Haze [%] | ASTM D1003 | 100 | 100 | 100 | 100 | 100 | 100 |
| Half Power Angle [“] | DIN 5036 | 52 | 26 | 49 | 60 | 41 | 61 |
| Light Intensity at 5° [%] | DIN 5036 | 98.0 | 96.0 | 99.0 | 98.0 | 98.0 | 98.0 |
| Light Intensity at 20° [%] | DIN 5036 | 87.0 | 58.0 | 87.0 | 93.0 | 80.0 | 93.0 |
| Light Intensity at 70° [%] | DIN 5036 | 21.0 | 4.0 | 22.0 | 28.0 | 12.0 | 34.0 |
| Dispersion Ability [%] | DIN 5036 | 55 | 32 | 55 | 62 | 47 | 65 |

1. A compound containing 60 to 99.98% by weight of a transparent thermoplastic resin, 0.01 to 20% by weight of inorganic particles on the basis of silicone dioxide with a particle size from 1 to 100 μm, and 0.01 to 20% by weight of polymer particles on an acrylate basis with core/shell morphology and with a particle size from 1 to 100 μm.

2. A compound according to claim 1, in which the inorganic particles on the basis of silicone dioxide represent amorphous silicic acid that exhibits a pH-value between 5 and 9 in aqueous suspension.

3. A compound according to claim 1 or 2, in which the transparent thermoplastic resin is aromatic polycarbonate.

4. A compound according to claim 3, in which the inorganic particles on the basis of silicone dioxide represent amorphous silicic acid that exhibits a pH-value from 5 to 9 in aqueous suspension, and which leads to an increase in the MVR of no more than 100 cm³/10 min. according to ISO 1133 when the silicic acid is compounded into polycarbonate in an amount of 5% by weight.

5. A compound according to claim 4, in which the amorphous silicic acid is uncoated.

6. Use of compounds according to one of the claims 1 to 5 for manufacturing moulds.

7. Technique for manufacturing multi-layered moulds by way of coextrusion, in which at least one layer is made of a compound according to one of the claims 1 to 5.

8. Mould obtainable from compounds according to one of the claims 1 to 5.

9. Mould obtainable from the technique according to claim 7, whereby at least one coextrusion layer comprises at least one UV-absorber making up from 0.1 to 20% by weight in relation to the coextrusion layer.

10. Mould according to claim 8 or 9, whereby the mould is a solid slab.
